(19) United States
(12) Patent Application Publication
(10) Pub. No.: US 2026/0074367 A1
(43) Pub. Date: Mar. 12, 2026

(54) Separator With Embedded Lithium-Ion Conductive Inorganic Material

(71) Applicant: APPLE INC., Cupertino, CA (US)

(72) Inventors: Wei Kah Tan, Campbell, CA (US); Shreshtha U. Kumar, Santa Clara, CA (US); Xingxing Zhang, San Jose, CA (US); Tingting Zhang, Campbell, CA (US); Wanjie Zhang, Beijing (CN); Erik D. Gillow, Redwood City, CA (US); Rajesh Kandibanda, Menlo Park, CA (US); Atish S. Patankar, Foster City, CA (US); Mark E Wilcox, Morgan Hill, CA (US)

(21) Appl. No.: 19/263,113

(22) Filed: Jul. 8, 2025

Related U.S. Application Data
(60) Provisional application No. 63/693,308, filed on Sep. 11, 2024.

(51) Int. Cl. H01M 50/434; H01M 50/417; H01M 50/426; H01M 50/429; H01M 50/443; H01M 50/446

(52) U.S. Cl. CPC H01M 50/434; H01M 50/417; H01M 50/426; H01M 50/4295; H01M 50/443; H01M 50/446

(57) ABSTRACT

A separator for an electrochemical cell has a layer of one or more polymer material, the layer having a thickness, and particles of one or more inorganic material that is lithium-ion conductive. The particles of the lithium-ion conductive inorganic material are embedded within the thickness of the layer of polymer material, each particle having a diameter ranging between 100 nm and 600 nm.

### CROSS-REFERENCE TO RELATED APPLICATIONS

This application claims the benefit of U.S. Provisional Application No. 63/693,308, filed on Sep. 11, 2024, the content of which is hereby incorporated by reference in its entirety herein for all purposes.

### TECHNICAL FIELD

This disclosure relates to a separator for an electrochemical cell having lithium-ion conductive material imbedded within a base separator material.

### BACKGROUND

Electrochemical cell impedance and performance depends in part on lithium-ion transportation within the electrochemical cell. The electrolyte and the inter-surface conductivity between the anode and separator and between the separator and cathode play key roles in lithium-ion transportation. Solid state electrolytes tend to suffer from poor inter-surface quality resulting in low adhesion between surfaces. The conventional separator does not improve lithium-ion transportation within the cell and may negatively impact the cell.

### SUMMARY

Disclosed herein is a separator for an electrochemical cell such as a lithium-ion battery, the separator having a layer of material in which particles of one or more lithium-ion conductive inorganic material is embedded. The disclosed separator having the embedded inorganic material improves the lithium-ion conductivity of the separator and accordingly the cell and battery. The improved lithium-ion conductivity reduces the overall cell impedance, resulting in longer battery cycle life. The embedded inorganic material also improves the integrity of the layer, which improves the overall safety of the battery. By embedding the inorganic material into a layer rather than coating two layers onto a base layer, the thickness of the separator, and accordingly the cell and battery, can be reduced.

An implementation of the separator for an electrochemical cell comprising a layer of material and particles of inorganic material that is lithium-ion conductive embedded within the layer of material. The material may be a polymer material. For example, the polymer material may be one or more of polyethylene (PE), polypropylene (PP), cellulose, and polyvinylidene fluoride (PVDF).

The inorganic material embedded in the layer may be one or more of Li₁₊ₓAlₓTi₂₋ₓ(PO₄)₃ (LATP), Li₁₊ₓAlₓGe₂₋ₓ(PO₄)₃ (LAGP), Li₇La₃Zr₂O₁₂ (LLZO), Li_{6.5}La₃Zr_{1.5}Ta_{0.5}O₁₂ (LLZTO), Li_{0.5}La_{0.5}TiO₃ (LLTO), and Li₃PO₄ (LiPON). Each particle of the inorganic material may have a diameter ranging between 100 nm and 600 nm.

In another implementation, a separator for an electrochemical cell consists of a layer of one or more polymer material, the layer having a thickness, and particles of one or more inorganic material that is lithium-ion conductive. The particles of the lithium-ion conductive inorganic material are embedded within the thickness of the layer of polymer material, each particle having a diameter ranging between 100 nm and 600 nm.

In another implementation, an electrochemical cell has a cathode, an anode, a separator interposed between the cathode and the anode, and an electrolyte. The separator comprises a layer of polymer material and particles of inorganic material that is lithium-ion conductive, the particles embedded within the layer of material.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of a separator as disclosed herein.

FIG. 2 is a side view of an electrochemical cell having the separator of FIG. 1 as disclosed herein.

### DETAILED DESCRIPTION

Lithium-ion transportation within an electrochemical cell plays a key role in the cell's impedance and performance. Lithium-ion transportation can be negatively impacted by poor adhesion between cell layers, the use of materials that do not benefit lithium-ion transportation, and increased cell thicknesses, as non-limiting examples. Solid state electrolytes may both increase the thickness of a cell and cause the interfaces between one or both of the solid electrolyte and anode and the solid electrolyte and the cathode to de-laminate. The poor adhesion between these interfaces impedes lithium-ion concentration, while the increased cell thickness may require a longer travel route for the lithium-ions.

Separators are an important element in lithium-ion batteries because they isolate the anode and cathode, allowing ionic conduction through the electrolyte while preventing electronic conduction. They also play a role in the safety, performance, and cost of the battery. However, conventional separators may both increase the thickness of a cell and may incorporate materials that do not benefit, and may actually impede, lithium-ion transportation through the cell. Conventional separators are typically a base layer of polyethylene (PE) or polypropylene (PP) with a ceramic layer of alumina or boehmite, for example, coated on both surfaces of the base layer. The ceramic layers may improve thermal and mechanical stability of the base layer but are not particularly lithium-ion conductive. Furthermore, each ceramic layer is 1 μm to 3 μm in thickness. As a battery may have between 10 and 30 cells, for example, these ceramic layers may increase a battery's thickness by upwards of 180 μm.

Disclosed herein is a separator for a lithium-ion battery having a layer of material in which particles of one or more lithium-ion conductive inorganic material is embedded. The disclosed separator having the embedded inorganic material improves the lithium-ion conductivity of the separator and accordingly the cell and battery. The improved lithium-ion conductivity reduces the overall cell impedance, resulting in longer battery cycle life. The embedded inorganic material also improves the integrity of the layer, which improves the overall safety of the battery. By embedding the inorganic material into a layer rather than coating two layers onto a base layer, the thickness of the separator, and accordingly the cell and battery, can be reduced. Reducing the thickness results in a gain of the volumetric energy density. The reduction in thickness may be significant, as a typical separator thickness is 4.5 μm to 12 μm, depending on the application. Eliminating two ceramic layers ranging in total from 2 μm to 6 μm per separator may achieve nearly a 50% reduction in the thickness of the separator.

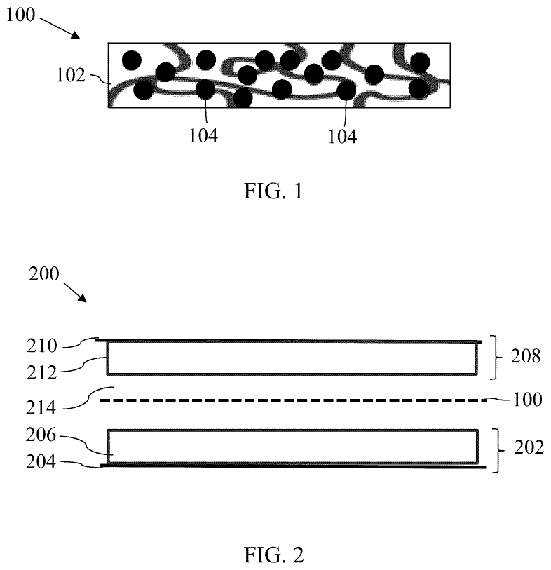

FIG. 1 illustrates a separator 100 for an electrochemical cell, the separator 100 having a layer 102 of material and particles 104 of inorganic material that is lithium-ion conductive embedded within the layer 102 of material. The separator 100 may consist of the layer 102 and the particles 104.

The material of the layer in the separator disclosed herein is a polymer material. As non-limiting examples, the polymer material may be one or a combination of PE, PP, cellulose, and polyvinylidene fluoride (PVDF).

The inorganic material of the separator disclosed herein may be Li₁₊ₓAlₓTi₂₋ₓ(PO₄)₃ (LATP), such as Li_{1.5}Al_{0.5}Ti_{1.5}(PO₄)₃, or Li₁₊ₓAlₓGe₂₋ₓ(PO₄)₃ (LAGP). Both materials provide high ionic conductivity, good air stability, and low raw material costs. Another example of the inorganic material is garnet-type lithium-ion electrolytes based on cubic Li₇La₃Zr₂O₁₂ (LLZO), also providing high ionic conductivity and high electrochemical stability, as well as excellent temperature characteristics. Another example of a garnet-type lithium-ion conductor is Li_{6.5}La₃Zr_{1.5}Ta_{0.5}O₁₂ (LLZTO). Further examples of the inorganic material of the disclosed separator include Li_{0.5}La_{0.5}TiO₃ (LLTO) and lithium phosphorus oxynitride, Li₃PO₄ (LiPON), known for its wide electrochemical stability, suitable for use with high-voltage active materials.

The inorganic material may be any one of these or may be a plurality of these materials. The inorganic material is in the form of particles having a diameter of between 100 nm and 600 nm, inclusive. These particles of inorganic material are embedded within the layer of material. In other words, as illustrated in FIG. 1, the layer of material has a thickness T, and the particles of inorganic material are embedded within the thickness of the layer as opposed to embedded on a surface of the layer. These inorganic materials have been used as solid electrolytes in solid state battery cells. However, when these materials are used as a solid electrolyte layer, the cells typically experience issued with delamination between the solid electrolyte layer and one or both of the anode or the cathode. Embedding the particles of these inorganic materials within the layer of material of the separator allows the cell to benefit from their high lithium-ion conductivity, among other benefits, while eliminating the delamination experienced when using these materials as the electrolyte.

An aspect of the disclosed embodiments is a lithium-ion battery. The power generating element of the lithium-ion battery includes a plurality of unit electrochemical cells each including a cathode active material layer, an electrolyte, and an anode active material layer. The cathode active material layer may be formed on a cathode current collector and electrically connected thereto, and the anode active material layer may be formed on an anode current collector and electrically connected thereto. A separator as disclosed herein is interposed between the cathode active material and the anode active material. The lithium-ion battery design is not limited and may be, for example, a winding cell battery or a stacked cell battery.

An electrochemical cell 200 is shown in cross-section in FIG. 2. The electrochemical cell 200 has an anode 202 having an anode current collector 204 and anode active material 206 disposed on the anode current collector 204. The electrochemical cell 200 also has a cathode 208 having a cathode current collector 210 and a cathode active material 212 disposed on the cathode current collector 210. The cathode 208 and the anode 202 are separated by electrolyte 214 and the separator 100 disclosed herein.

The cathode current collector 210 can be, for example, an aluminum sheet or foil.

Cathode active materials 212 are those that can occlude and release lithium-ions, and can include one or more oxides, chalcogenides, and lithium transition metal oxides which can be bonded together using binders and optionally conductive fillers such as carbon black. Lithium transition metal oxides can include, but are not limited to, LiCoO_{2,} LiNiO_{2,} LiNi_{0.8}Co_{0.15}Al_{0.05}O₂, LiMnO₂, Li(Ni_{0.5}Mn_{0.5})O₂, LiNiₓCo_{y}Mn_{z}O₂, Spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. As needed, the cathode active material 212 can contain an electroconductive material, a binder, etc.

The anode active material 206 can be a silicon-based material. The silicon-based active material is not limited except to include some form of silicon or silicon alloy with a volumetric capacity of greater than or equal to 500 mAh/cc. Non-limiting examples of silicon-based anode material include Si, SiOx, and Si/SiOx composites. The anode active material 206 may also be, as non-limiting examples, alloy anodes (such as Al, Sn, Mg, Ag, Sb, and their alloys); conversion-type transition-metal compounds such as transition-metal sulfides, oxides, phosphides, nitrides, fluorides, and selenides; and transition metal compounds such as iron oxide, nitrides, carbides, oxalates, and chalcogenides. The anode active material 206 may also be graphite.

A conducting agent may be used with the anode active material 206. Further, one or more of a binder and a solvent may be used to prepare a slurry that is applied to the current collector, for example. The anode current collector 204 can be a copper or nickel sheet or foil, as non-limiting examples.

For the electrolyte 214, a liquid electrolyte or a gel electrolyte known to those skilled in the art may be used. As examples, the liquid electrolyte may be in the form of a solution in which a lithium salt is dissolved in an organic solvent. As non-limiting examples, the liquid electrolyte may include a cyclic carbonate (e.g., ethylene carbonate (EC) or propylene carbonate, a cyclic ether such as tetrahydrofuran (THF) or tetrahydropyran (TH), a glyme such as dimethoxyethane (DME) or diethoxyethane, an ether such as diethylether (DEE) or methylbutylether (MBE), their derivatives, and any combinations and mixtures thereof. The lithium salt may be one or more of LiPF₆, LiClO₄, LiBF₄, LiAsF₆, as non-limiting examples.

The gel electrolyte may be in the form of a gel in which the above-mentioned liquid electrolyte is impregnated into a matrix polymer composed of an ion conductive polymer.

The electrolyte 214 may be an ionic liquid-based electrolyte mixed with a lithium salt. The ionic liquid may be, for example, at least one selected from N-Propyl-N-methylpyrrolidinium bis(flurosulfonyl)imide, N-methyl-N-propylpyrrolidinium bis(trifluoromethanesulfonyl)imide, N-butyl-N-methylpyrrolidinium bis(trifluoromethylsulfonyl)imide, 1-butyl-3-methylimidazolium bis(trifluoromethylsulfonyl)imide, and 1-ethyl-3-methylimidazolium bis(trifluoromethylsulfonyl)imide. The salt can be or include, for example, a fluorosulfonyl (FS0) group, e.g., lithium bisfluorosulfonylimide (LiN(FS0₂)₂ (LiFSI), LiN(FS0₂)₂, LiN(FS0₂) (CF₃S0₂), LiN(FS0₂)(C₂F₅S0₂) .

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A separator for an electrochemical cell, the separator comprising:
a layer of material; and
particles of inorganic material that is lithium-ion conductive embedded within the layer of material.

2. The separator of claim 1, wherein the material is a polymer material.

3. The separator of claim 2, wherein the polymer material is one or more of polyethylene (PE), polypropylene (PP), cellulose, and polyvinylidene fluoride (PVDF).

4. The separator of claim 1, wherein the inorganic material is one or more of Li₁₊ₓAlₓTi₂₋ₓ(PO₄)₃ (LATP), Li₁₊ₓAlₓGe₂₋ₓ(PO₄)₃ (LAGP), Li₇La₃Zr₂O₁₂ (LLZO), Li_{6.5}La₃Zr_{1.5}Ta_{0.5}O₁₂ (LLZTO), Li_{0.5}La_{0.5}TiO₃ (LLTO), and Li₃PO₄ (LiPON).

5. The separator of claim 1, wherein each particle has a diameter ranging between 100 nm and 600 nm.

6. An electrochemical cell comprising the separator of claim 1, and further comprising:
a cathode;
an anode, wherein the separator is interposed between the cathode and the anode; and an electrolyte.

7. The electrochemical cell of claim 6, wherein the electrolyte is a liquid electrolyte.

8. A separator for an electrochemical cell, the separator consisting of:
a layer of one or more polymer material, the layer having a thickness; and
particles of one or more inorganic material that is lithium-ion conductive, the particles embedded within the thickness of the layer, each particle having a diameter ranging between 100 nm and 600 nm.

9. The separator of claim 8, wherein the one or more polymer material is one or more of polyethylene (PE), polypropylene (PP), cellulose, and polyvinylidene fluoride (PVDF).

10. The separator of claim 8, wherein the one or more inorganic material is one or more of Li₁₊ₓAlₓTi₂₋ₓ(PO₄)₃ (LATP), Li₁₊ₓAlₓGe₂₋ₓ(PO₄)₃ (LAGP), Li₇La₃Zr₂O₁₂ (LLZO), Li_{6.5}La₃Zr_{1.5}Ta_{0.5}O₁₂ (LLZTO), Li_{0.5}La_{0.5}TiO₃ (LLTO), and Li₃PO₄ (LiPON).

11. An electrochemical cell, comprising:
a cathode;
an anode;
a separator interposed between the cathode and the anode, the separator comprising:
a layer of polymer material; and
particles of inorganic material that is lithium-ion conductive, the particles embedded within the layer of material; and
an electrolyte.

12. The electrochemical cell of claim 11, wherein the polymer material is one or more of polyethylene (PE), polypropylene (PP), cellulose, and polyvinylidene fluoride (PVDF).

13. The electrochemical cell of claim 11, wherein the inorganic material is one or more of Li₁₊ₓAlₓTi₂₋ₓ(PO₄)₃ (LATP), Li₁₊ₓAlₓGe₂₋ₓ(PO₄)₃ (LAGP), Li₇La₃Zr₂O₁₂ (LLZO), Li_{6.5}La₃Zr_{1.5}Ta_{0.5}O₁₂ (LLZTO), Li_{0.5}La_{0.5}TiO₃ (LLTO), and Li₃PO₄ (LiPON).

14. The electrochemical cell of claim 11, wherein the electrolyte is a liquid electrolyte.

15. The electrochemical cell of claim 11, wherein the anode comprises an anode current collector and anode active material on the anode current collector.

16. The electrochemical cell of claim 15, wherein the anode active material is a silicon-based material.
